(19) United States
(12) Patent Application Publication
(10) Pub. No.: US 2007/0291320 A1
(43) Pub. Date: Dec. 20, 2007

(54) Ridged surface structure facilitating display of multiple engraved patterns

(75) Inventor: Chung-Lung Chen, Taipei City (TW)

Correspondence Address: RABIN & Berdo, PC, 1101 14TH STREET, NW, SUITE 500, WASHINGTON, DC, 20005, US

(73) Assignee: BUTTON INTERNATIONAL CO. LTD.

(21) Appl. No.: 11/455,851

(22) Filed: Jun. 20, 2006

(51) Int. Cl. B41C 1/04

(52) U.S. Cl. 358/3.29

(57) ABSTRACT

A ridged surface structure includes a plurality of parallelly arrayed and regularly spaced rectangular-sectioned ridges, each of the ridges may be cut at one or both lengthwise upper edges thereof to produce bevel surfaces at different positions, so that the bevel surfaces on the lengthwise upper edges at the same side of the ridges together produce at least one engraved pattern, and multiple overlapped engraved patterns may therefore be produced on the ridged surface and observed at the same time from different viewing angles. The ridged surface structure may be produced with many different materials, including plastics, reflective materials, and low-reflective materials, and may be widely applied to mass-produced products on which multiple marks or designs are to be displayed at the same time without increasing the manufacturing cost of the products.

### FIELD OF THE INVENTION

The present invention relates to a ridged surface structure, more particularly to a ridged surface structure including a plurality of parallelly arrayed and regularly spaced rectangular-sectioned ridges, of which one or two lengthwise upper edges may be independently cut to produce bevel surfaces at different positions, so as to display on the ridged surface structure at least two overlapped engraved patterns that could always be observed at the same time from different viewing angles.

### BACKGROUND OF THE INVENTION

Some products are provided on a surface with a three-dimensional (3D) pattern to display a specific mark or logo. For the same 3D pattern to create different scenes when being viewed from different viewing angles, some engraving skills and the light refraction principle are frequently employed. There is a so-called “invisible engraving skill” being widely employed in the engraving field for producing different 3D patterns on coins, so that the engraved patterns are normally invisible but can be seen only when the coins are turned to a certain angle or observed from some specific viewing angles.

FIG. 1 schematically shows a conventional surface structure on which the invisible engraving skill is employed to create more than one pattern. As shown, such surface structure is very often provided on a coin A, and includes a plurality of protrusions A1 continuously arrayed to form a matrix, so that a downward tapered tiny space A2 exists between any two adjacent protrusions A1. With the so-called invisible engraving skill, a plurality of reflective bevel surfaces B1 having a specific reflection angle are formed on some of the protrusions A1 in the tapered tiny spaces A2 according to a predetermined design. When light is refracted from the reflective bevel surfaces B1, a different pattern may be observed.

With the invisible engraving skill, more than one pattern may be engraved on the coin A. To achieve this purpose, the matrix of the protrusions A1 is used as a basic pattern. A first mark pattern is then produced by forming the reflective bevel surfaces B1 having a first reflection angle on the protrusions A1 in the tiny spaces A2 according to a predetermined design. Whereby when an observer looks at the coin at a vertically downward viewing angle, the basic pattern formed from the protrusions A1 could be clearly observed. And, when the observer turns the coin A to a first specific angular position corresponding to the first reflection angle of the reflective bevel surfaces B1, the first mark pattern could be clearly observed when light is reflected from the bevel surfaces B1, as shown at the right side of FIG. 1. When the coin A is repeatedly turned between the front and the first specific angular position before the observer, the basic pattern and the first mark pattern are repeatedly and alternately displayed to create a unique visual effect.

A third pattern, that is, a second mark pattern, may be further produced on the coin A using the so-called invisible engraving skill. To do this, a plurality of reflective bevel surfaces B2 having a second reflection angle are produced on some of the protrusions A1 in the tiny spaces A2 at positions different from the reflective bevel surfaces B1. Whereby when the coin A is turned to a second specific angular position corresponding to the second reflection angle of the bevel surfaces B2, and light is reflected from the bevel surfaces B2, the second mark pattern could be clearly observed. When the coin A is repeatedly turned among the front, the first specific angular position, and the second specific angular position before the observer, the basic pattern, the first mark pattern, and the second mark pattern are repeatedly and alternately displayed to create a unique visual effect.

With the so-called invisible engraving skill, only one side of each tiny space A2 may be engraved to form either the first or the second reflective bevel surface B1 or B2. In other words, it is impossible to produce two bevel surfaces B1, B2 having two different reflection angles in one tiny space A2 between two adjacent protrusions A1. Each of the bevel surfaces B1, B2 allows light refraction or image display in only one single direction. When an observer turns the coin A to the first or the second specific angular position, only the first or the second mark pattern can be observed. That is, while multiple patterns could be produced on the coin A using the invisible engraving skill, these patterns could only be displayed one at a time due to different reflection angles.

Therefore, the multiple patterns created on the coin A using the invisible engraving skill could not create the visual effect of displaying multiple independent or overlapped patterns at the same time from all viewing angles.

Moreover, the patterns created on the coin A using the invisible engraving skill are observable based on the reflective property of the material for making the coin A. That is, with the bevel surfaces B1, B2 formed on the reflective material of the coin A, light is refracted from the coin A at different reflection angles to display different patterns. Therefore, the patterns produced with the invisible engraving skill are preferably formed on materials with high reflectivity, such as metal materials, to obtain the desired visual effect. Other non-reflective or low-reflective materials are not suitable for the invisible engraving skill. Therefore, there are many non-metal products that need to display but could not be provided with multiple marks or logos through the invisible engraving skill.

That is, the invisible engraving skill can only be employed on limited types of material, and the patterns so created could not be displayed at the same time from any viewing angles.

### SUMMARY OF THE INVENTION

A primary object of the present invention is to provide a ridged surface structure on which multiple overlapped engraved patterns may be easily produced and always observable at the same time from different viewing angles.

Another object of the present invention is to provide a ridged surface structure on which multiple overlapped engraved patterns may be easily produced and always observable at the same time from different viewing angles, no matter what type of material the ridged surface structure is.

To achieve the above and other objects, the ridged surface structure of the present invention includes a plurality of parallelly arrayed and regularly spaced rectangular-sectioned ridges, each of the ridges may be cut at one or both lengthwise upper edges thereof to produce bevel surfaces at different positions, so that the bevel surfaces on the lengthwise upper edges at the same side of the ridges together produce at least one engraved pattern, and multiple overlapped engraved patterns may therefore be produced on the ridged surface and are always observable at the same time from different viewing angles.

The ridged surface structure may be produced with many different materials, including plastics, reflective materials, and low-reflective materials, and may be widely applied to mass-produced products on which multiple marks or designs are to be displayed at the same time without increasing the manufacturing cost of the products.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectional view showing a conventional surface structure for forming multiple engraved patterns;

FIG. 2 is a sectional view of a ridged surface structure facilitating display of multiple engraved patterns according to a first embodiment of the present invention;

FIG. 3 is a top plan view of the ridged surface structure of FIG. 2 having two overlapped engraved patterns provided thereon;

FIGS. 3A and 3B are enlarged views of the circled are as A and B of FIG. 3, respectively;

FIG. 4 shows the two patterns engraved on the ridged surface structure of the present invention may be observed at the same time from the same viewing angle;

FIG. 5 is a top perspective view of the ridged surface structure of FIG. 3 observed from a first viewing angle;

FIG. 5A is an enlarged view of the circled are a C of FIG. 5;

FIG. 6 is a top perspective view of the ridged surface structure of FIG. 3 viewed from a second viewing angle;

FIG. 6A is an enlarged view of the circled are a D of FIG. 6; and

FIG. 7 is a top perspective view of a ridged surface structure facilitating display of multiple engraved patterns according to a second embodiment of the present invention; and

FIG. 7A is an enlarged view of the circled are a E of FIG. 7.

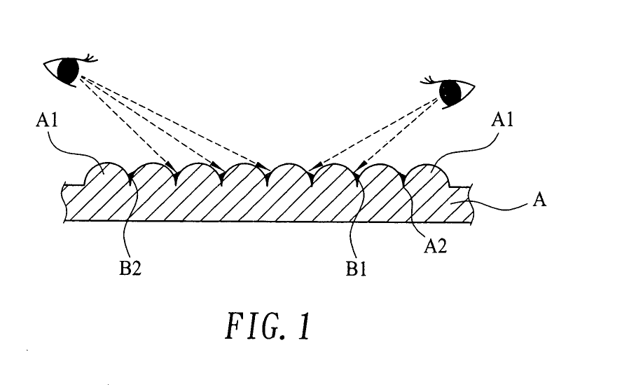

### DETAILED DESCRIPTION OF THE PREFERRED EMBODIMENTS

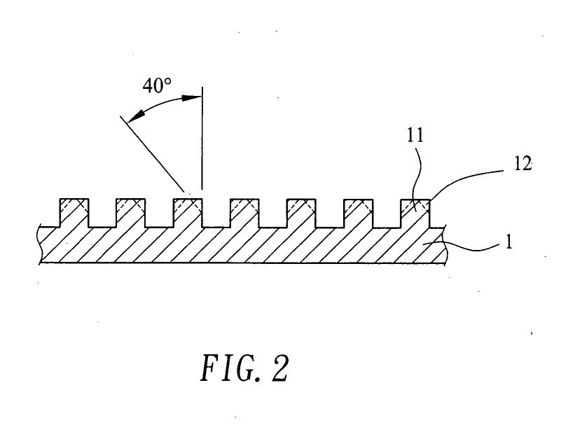

Please refer to FIGS. 2 through 4, in which a ridged surface structure facilitating display of multiple engraved patterns according to a first embodiment of the present invention is shown. As shown, the ridged surface structure includes a plurality of rectangular-sectioned ridges 11 formed and arrayed on a surface of a main body 1 to be engraved, such that a particular matrix is produced. In the illustrated first embodiment, the rectangular-sectioned ridges 11 are parallelly arrayed and regularly spaced straight ridges. Each of the ridges 11 has two lengthwise upper edges 12, which may be independently beveled at one or more specified positions, so that at least two different and partially overlapped patterns may be engraved on the ridged surface structure of the present invention to produce visual changes when an observer views the engraved ridged surface structure from different viewing angles.

The main body 1 to be engraved may include a plastic material. In a feasible embodiment of the present invention, the main body 1 may includes a low reflective material or a reflective material. In an ideal embodiment of the present invention, the ridges 11 are beveled at specified positions on both of the two lengthwise upper edges 12.

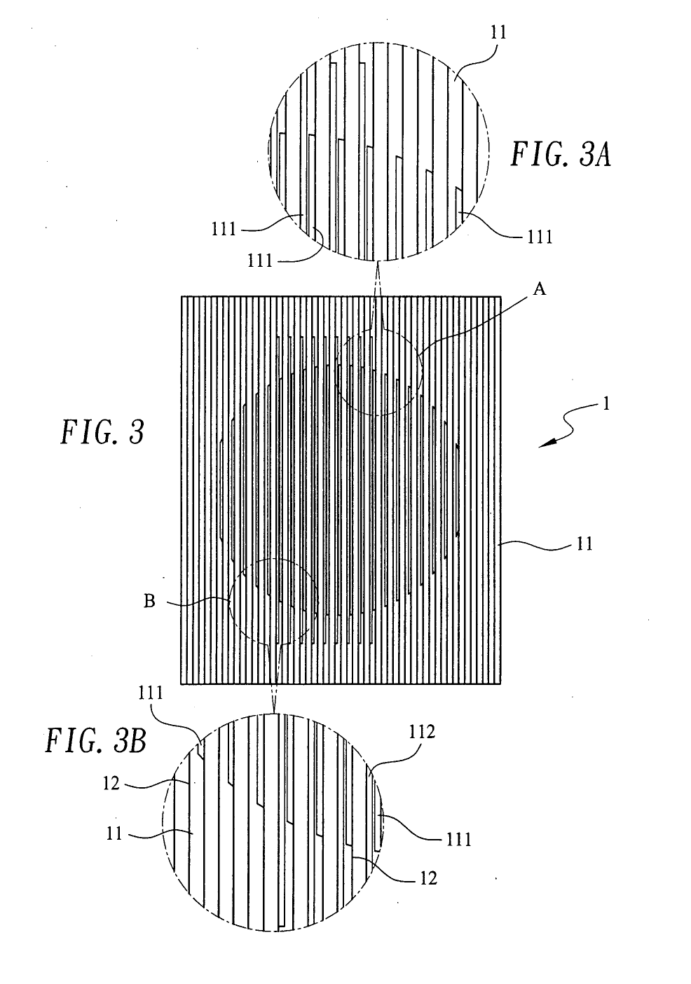

In the illustrated first embodiment, the main body 1 is formed on one surface with a plurality of parallelly arrayed rectangular-sectioned ridges 11, and the ridges 11 are engraved at two lengthwise upper edges 12 according to two patterns to be displayed, such as a round and a rectangular pattern as shown in FIG. 3, so that a first bevel surface 111 and a second bevel surface 112 are separately produced at predetermined positions on the two lengthwise upper edges 12 of each ridge 11 to present the desired round and the rectangular pattern.

In the illustrated first embodiment, the round pattern is located at a central are a of the main body 1, and the rectangular pattern overlaps the round pattern with two lengthwise ends extended from a circumference of the round pattern. The round pattern is produced by the first bevel surfaces 111 engraved on one of the two lengthwise upper edges 12 at the same side of some of the ridges 11 according to a predetermined pattern, while the rectangular pattern is produced by the second bevel surfaces 112 engraved on the other lengthwise upper edge 12 at the same side of some of the ridges 11 according to another predetermined pattern. As can be clearly seen from FIGS. 3A and 3B, the ridges 11 in an are a at where the rectangular pattern and the round pattern overlaps each other on the main body 1 are engraved at both of the lengthwise upper edges 12 to form the first and the second bevel surfaces 111, 112 at the same time. Therefore, two different engraved patterns are displayed on the main body 1.

When an observer looks at the patterns in front of the main body 1 at a downward viewing angle, both of the round and rectangular patterns produced on the ridges 11 by the first bevel surfaces 111 and the second bevel surfaces 112, respectively, could be observed. In the are as near two sides of the round pattern that do not overlap the rectangular pattern, the ridges 11 are engraved on only one lengthwise upper edge 12 at the same side to form the first bevel surfaces 111. On the other hand, in the are a at where the round pattern and the rectangular pattern overlap each other, the ridges 11 are engraved on both lengthwise upper edges 12 to form the first and the second bevel surfaces 111, 112. Therefore, a visual effect of displaying two patterns looked like having different depths is created.

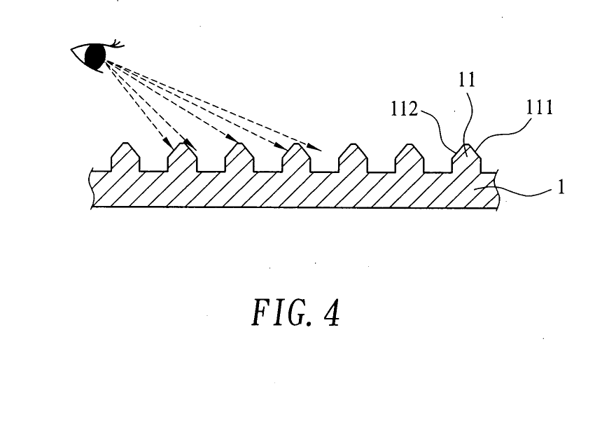

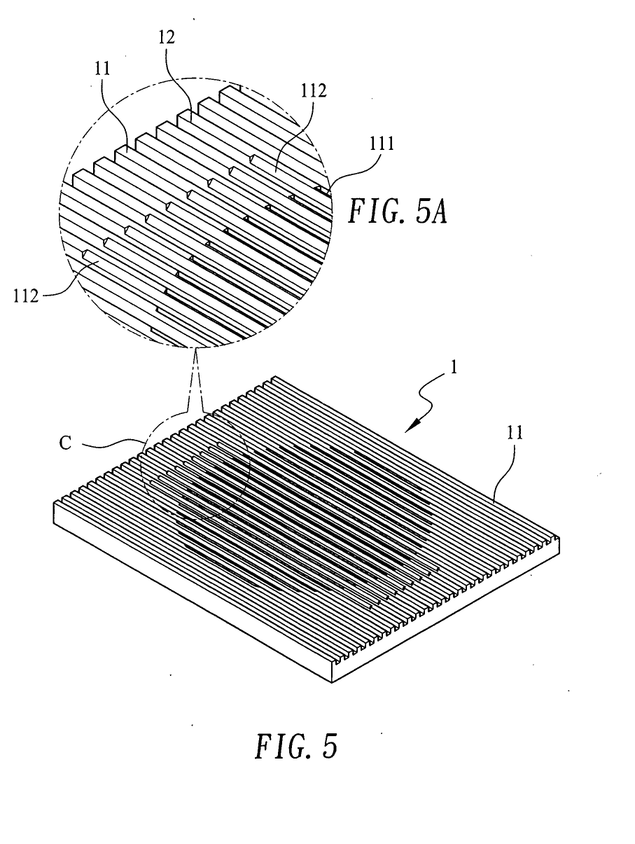

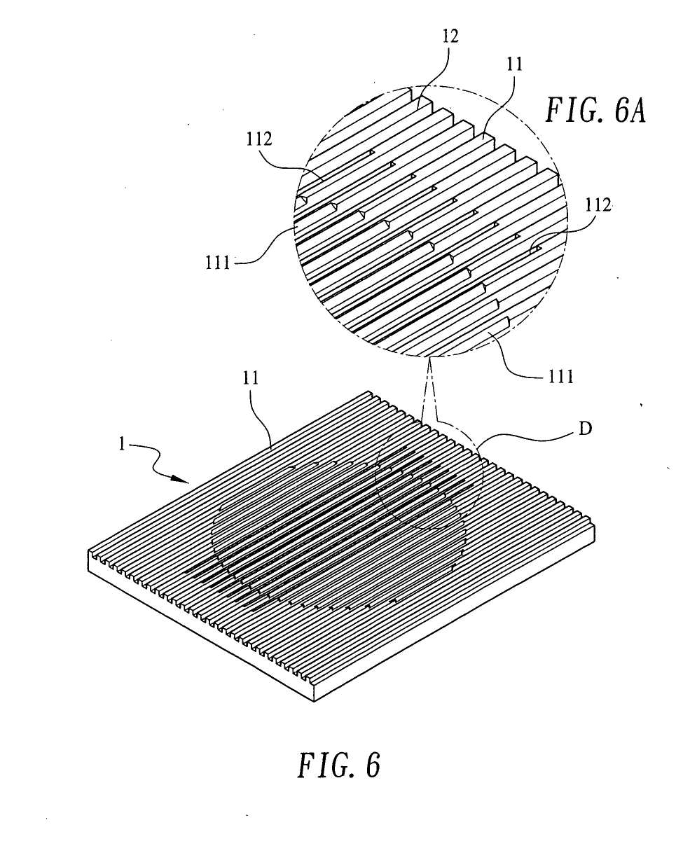

Please refer to FIGS. 4 through 6. When the main body 1 is turned to a different angular position or is observed from a different viewing angle, the first and the second bevel surfaces 111, 112 at two sides of the parallel ridges 11 can still be seen at the same time, making the round pattern and the rectangular pattern on the main body 1 presented as they are superposed. FIG. 5A is an enlarged view of the circled are a C on the main body 1 in FIG. 5. When the main body 1 is observed from the illustrated viewing angle, the rectangular pattern produced by the second bevel surfaces 112 engraved at one lengthwise upper edge at the same side of the ridges 11 can be very clearly seen, while the round pattern produced by the first bevel surfaces 111 engraved at the other lengthwise edge of the other side of the ridges 11 may also be seen at the same time. Again, a visual effect of displaying two overlapped patterns looked like having different depths is created. And, when the main body 1 is observed from another viewing angle as shown in FIGS. 6 and 6A, the round pattern and the rectangular pattern produced by the first and the second bevel surfaces 111 and 112, respectively, can still be clearly seen at the same time. Therefore, when the ridged surface structure facilitating display of multiple engraved patterns according to the present invention is employed on a product, two or more specific marks or logos for the product may be significantly displayed no matter the product is observed from what viewing angle, creating a unique visual effect to attract consumers. Since the multiple patterns engraved on the ridged surface structure of the present invention can be observed from any viewing angle independent of light reflection or refraction, the present invention may be applied to a low reflective material, such as ceramic, wood, cement wall, plastics, etc. Of course, the present invention may also be applied to a reflective material. In this case, the visual effect created via engraving the ridged surface structure of the present invention is even better. What is most important is the engraving implemented on the ridges 11 of the ridged surface structure of the present invention to produce the bevel surfaces 111, 112 does not increase any manufacturing cost of the product.

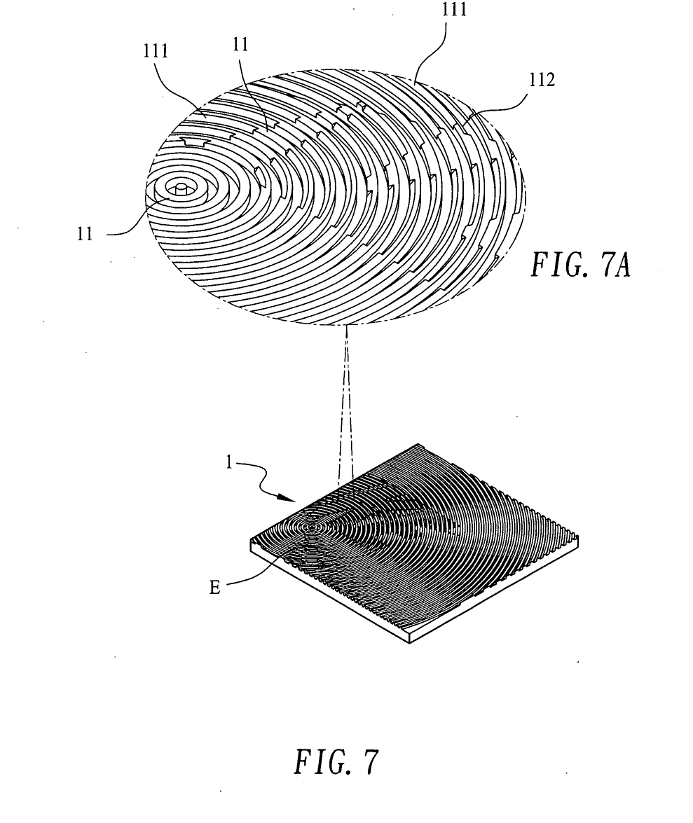

FIGS. 7 and 7A show a second embodiment of the present invention. In the second embodiment, the main body 1 is formed on at least one surface with a plurality of rectangular-sectioned curved ridges 11 that are regularly spaced and parallelly arrayed to show a plurality of concentric circles. The concentric ridges 11 may be engraved at predetermined positions on two lengthwise upper edges according to desired word patterns or other figurative patterns. In the second embodiment shown in FIG. 7, word patterns showing English letters K and E are produced near one side of the main body 1, and an angular pattern is produced between the two word patterns K and E to overlap the two letters. The word patterns are presented by first bevel surfaces 111 engraved on one lengthwise upper edge at the same side of the concentric ridges 11, while the angular pattern is presented by second bevel surfaces 112 engraved on the lengthwise upper edge at the other side of the concentric ridges 11. In the are as at where the word patterns and the angular pattern overlap one another, the ridges 11 are engraved at both lengthwise upper edges to produce the first and the second bevel surfaces 111, 112 at the same time. Again, the overlapped word patterns and figurative patterns on the main body 1 together create a changeful visual effect.

With the ridged surface structure facilitating display of multiple engraved patterns according to the present invention, the two lengthwise upper edges 12 of the ridges 11 may be freely and independently engraved at different positions according to desired patterns to create at least two images, which can always be seen at the same time by a consumer from any viewing angle relative to the main body 1. Therefore, multiple overlapped patterns looked like having different depths may be created and displayed on the main body 1 at the same time simply by engraving the two lengthwise upper edges 12 of the ridges 11 to produce the bevel surfaces 111, 112 at different positions.

In the present invention, the presentation of multiple overlapped patterns on the main body 1 from any viewing angle is achieved by forming the bevel surfaces at two sides of a plurality of rectangular-sectioned ridges instead of utilizing the principles of light reflection and refraction. Therefore, the engraving effect is not influenced by the material type of the main body 1. The main body 1 may be of a low reflective material or a reflective material. Therefore, the present invention may be widely applied on many products on which multiple marks are to be displayed at any time at any viewing angle.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A ridged surface structure facilitating display of multiple engraved patterns, comprising a main body being provided on at least one surface to display engraved patterns with a plurality of parallelly arrayed and regularly spaced rectangular-sectioned ridges, each of said ridges having two lengthwise upper edges, which can be independently cut to produce bevel surfaces at predetermined positions, such that said bevel surfaces on said lengthwise upper edges at the same side of said ridges together produce at least one engraved pattern, and multiple overlapped engraved patterns may therefore be produced on said is at least one surface of said main body and observed at the same time from different viewing angles relative to said main body.

2. The ridged surface structure facilitating display of multiple engraved patterns as claimed in claim 1, wherein said main body comprises a plastic material.

3. The ridged surface structure facilitating display of multiple engraved patterns as claimed in claim 1, wherein said main body comprises a low-reflective material.

4. The ridged surface structure facilitating display of multiple engraved patterns as claimed in claim 1, wherein said main body comprises a reflective material.
